(19) United States
(12) Patent Application Publication
(10) Pub. No.: US 2005/0135796 A1
(43) Pub. Date: Jun. 23, 2005

(54) In line oil field or pipeline heating element

(76) Inventor: Michael Ray Carr SR., Minden, LA (US)

Correspondence Address: National IP Rights Center, LLC, Suite 400, 550 Township Line Road, Blue Bell, PA, 19422, US

(21) Appl. No.: 10/886,526

(22) Filed: Jul. 7, 2004

Related U.S. Application Data
(63) Continuation of application No. 10/614,580, filed on Dec. 9, 2003, now abandoned.

(51) Int. Cl. H05B 3/40; F24H 1/10

(52) U.S. Cl. 392/478

(57) ABSTRACT

An apparatus for heating crude oil or any other substance as it passes through the production tubing, flow lines or field lines by incorporating the heating apparatus as a section or joint of the piping system. Heating apparatus comprising of an inner hollow core with a plurality of holes. A heat source; supplied with electrical current by a suitable source of electrical energy or steam source which may be employed. Outer cases. Tapered caps and on each end of the outer cases and threaded couplings and attached to the apparatus to allow integration of the heating apparatus to existing piping system.

### CROSS-REFERENCE TO RELATED APPLICATIONS

This application claims the priority of Provisional Patent Application No. 60/397,723 filing date Jul. 22, 2002 and U.S. Ser. No. 10/614,580, filed Jul. 7, 2003, and International Patent Application filed Jul. 7, 2004.

### FIELD OF THE INVENTION

This invention is directed to the issue of raising the temperature of steam, crude oil or petroleum-related products as they flow through production tubing, flow lines or field lines so as to prevent or eliminate the formation and accumulation of paraffin or paraffin-like deposits.

### BACKGROUND OF THE PRIOR ART

From the beginning of crude oil discovery and production, one of the most expensive problems that producers have encountered is the build-up of paraffin and paraffin-like deposits in the production tubing flow lines and field lines. It is not uncommon that the flow of oil from a well is completely stopped due to paraffin deposition.

Furthermore, deposition of paraffin and paraffin-like deposits in flow lines and field lines also result in completely clogged pipes. This results in increased pumping and maintenance cost for the producer. This problem continues today because all previous efforts related to paraffin problems have been methods of treating the paraffin deposition after it occurs. No prior effort has been directed towards the prevention of paraffin deposits in the production tubing, flow lines or field lines. All prior art referred to below have been directed towards dissolving the paraffin deposits after solidification occurs.

The need to prevent or eliminate paraffin deposits from piping systems utilized in the production and transportation of crude oil is obvious. In some areas, wells decline in productivity at a more or less rapid rate because of the deposition of such deposits in the piping systems. Pipe capacities are frequently reduced to a small fraction of their rated capacities. Ultimately, such pipes may be found completely clogged by paraffin deposits.

Various techniques have been employed for the removal of paraffin residue in production tubing, flow lines, field lines and the like. One such method is the so-called hot oil treatment. This method utilizes steam pumped under great pressure between the casing and tubing. The pressure applied during this process forces paraffin residue into the producing formation. The effects of the pressure on the producing zone frequently results in clogged perforations and ultimately the decline or loss of production. The hot oil method is also time consuming, requires down time to complete, is expensive and presents increased risks.

Additionally, another method commonly used in the oil industry to treat paraffin deposition requires stopping production and to retrieve the tubing, steam or scrape the inner wall to remove the deposits and then replacing the tubing strand back into the well. This is also a very time consuming and costly procedure that fails to prevent future paraffin deposition in the pipes, and merely maintenances the problem. The risk of loss of production while the well is shut-in, coupled with the maintenance expense, renders many wells unprofitable to produce.

Solvents are another method of treating paraffin problems. The use of solvents has met with limited success. The varying composition of crude oil from one zone to another as well as one well to another limited the effectiveness of solvents. The process of using solvents is expensive as well as experimental from one well to the next, as each well requires a different combination of chemicals.

Prior systems have been directed to combinations of heat and chemicals to treat paraffin deposition. The below list of patents and references cited includes all various methods discussed above for the treatment of paraffin in oil wells. However, none of the prior arts referenced prevent the deposition of paraffin in the piping systems of the oil industry. All referenced prior arts are attempts at treating or cleaning up the solidified paraffin once it occurs. Examples of these systems include: U.S. Pat. No. 47,410 to Fraser (1865); U.S. Pat. No. 231,287 to Digman et al (1880); U.S. Pat. No. 457,457 to Robison et al (1891); U.S. Pat. No. 522,737 to Lucock (1894); U.S. Pat. No. 573,142 to Flanegin (1896); U.S. Pat. No. 762,628 to Gardner (1904); U.S. Pat. No. 766,313 to Yoast (1904); U.S. Pat. No. 780,279 to Gardner (1905); U.S. Pat. No. 784,454 to Waring (1905); U.S. Pat. No. 884,424 to Seymour et al (1908); U.S. Pat. No. 972,308 to Williamson (1910); U.S. Pat. No. 1,082,971 to Pick (1913); U.S. Pat. No. 1,095,365 to Williamson (1914); U.S. Pat. No. 1,169,262 to Huff (1916); U.S. Pat. No. 1,232,736 to Truman et al (1920); U.S. Pat. No. 1,360,404 to Hollister et al (1920); U.S. Pat. No. 1,368,404 to Loftus (1921); U.S. Pat. No. 1,383,670 to Stephens (1921); U.S. Pat. No. 1,426,407 to Pennington (1922); U.S. Pat. No. 1,450,658 to Warnick (1923); U.S. Pat. No. 1,457,690 to Brine (1923); U.S. Pat. No. 1,464,618 to Pershing (1923); U.S. Pat. No. 1,477,802 to Beck (1923); U.S. Pat. No. 1,504,208 to Brine (1924); U.S. Pat. No. 1,540,648 to Pershing (1925); U.S. Pat. No. 1,646,599 to Schaefer (1927); U.S. Pat. No. 1,672,200 to Buck (1928); U.S. Pat. No. 1,690,994 to Powell (1928); U.S. Pat. No. 1,701,884 to Hogle (1929); U.S. Pat. No. 1,761,227 to Pasley (1930); U.S. Pat. No. 1,776,997 to Downey (1930); U.S. Pat. No. 1,839,632 to Agnew (1932); U.S. Pat. No. 2,202,034 to Thomas (1940); U.S. Pat. No. 2,208,087 to Somers (1940); U.S. Pat. No. 2,244,256 to Looman (1941); U.S. Pat. No. 2,260,916 to Rial (1941); U.S. Pat. No. 2,332,708 to Freeman (1943); U.S. Pat. No. 2,484,063 to Ackley (1949); U.S. Pat. No. 2,500,305 to Ackley (1950); U.S. Pat. No. 2,632,836 to Ackley (1953); U.S. Pat. No. 2,660,249 to Jakosky (1953); U.S. Pat. No. 2,666,487 to Bowman (1954); U.S. Pat. No. 2,685,930 to Albaugh (1954); U.S. Pat. No. 2,808,110 to Spitz (1957); U.S. Pat. No. 2,836,248 to Covington (1958); U.S. Pat. No. 2,998,066 to Nixon, Sr. (1961); U.S. Pat. No. 3,163,745 to Boston (1964); U.S. Pat. No. 3,279,541 to Knox et al (1966); U.S. Pat. No. 3,410,347 to Triplett et al (1968); U.S. Pat. No. 3,437,146 to Everhart et al (1969); U.S. Pat. No. 3,614,986 to Gill (1971); U.S. Pat. No. 3,828,161 to Yamaguchi (1974); U.S. Pat. No. 3,943,330 to Pollock et al (1976); U.S. Pat. No. 4,026,358 to Allen (1977); U.S. Pat. No. 4,178,993 to Richardson et al (1979); U.S. Pat. No. 4,219,083 to Richardson et al (1980); U.S. Pat. No. 4,285,401 to Erickson (1981); U.S. Pat. No. 4,330,037 to Richardson et al (1982); U.S. Pat. No. 4,399,868 to Richardson et al (1983); U.S. Pat. No. 4,790,375 to Bridges (1988); U.S. Pat. No. 4,911,239 to Winckler et al (1990); U.S. Pat. No. 5,120,935 to Nenninger (1992); U.S. Pat. No. 5,247,994 to Nenninger (1993); U.S. Pat. No. 5,282,263 to Nenninger (1994); U.S. Pat. No. 5,400,430 to Nenninger (1995). Foreign Patent Documents: 1,182,392 CA. (1985); 2,504,187 to FR. (1982); 1,298,354 to SU. (1987); 8,810,356 to WO. (1988).

Other references include: Nenninger et al, “Optimizing Hot Oiling/Watering Jobs to Minimize Formation Damage”, Petro. Society of CIM/Soc. Of Petro Eng, 1990; Nelson et al, “Oil Recovery By Thermal Methods”, Pt. 11, the petroleum engineer, February, 1959; “High Temperature Thermal Techniques for Stimulating Oil Recovery”, P. D. White et al, J. of Petro. Technology, pp. 1007-1011, September, 1965; R. Van A. Mills The Paraffin Problem in Oil Wells December 1923; John Power Removing Paraffin Deposits from Wells with Electric Heater 1928; L. G. E. Bignell Electric Heaters Remove Paraffin Nov. 14, 1929; Frank V. Eaton Applications of Heat Increases Production in Wyoming Field Apr. 22, 1943; H. E. Allen and R. K. Davis “Electric Formation Heaters and Their Application” Apr. 1954; K. G. Parrent “Bottom Hole Heaters” May 1970; World Oil “AC Current Heats Heavy Oil for Extra Recovery” May 1970; Dr. S. M. Faroug Ali “Well Stimulation by Downhole Thermal Methods” Oct. 1973; D. L. Currans “Electroflood Proves Technically Feasible” January 1980; Edward T. Yukl & Andrew W. Marr, Jr. “process Solves Paraffin Buildup in Tubing” Aug. 8, 1988; Petrotherm Electric Bottom-Hole Heating System.

All of these systems have had minimal success in addressing the paraffin problem in wells and pipelines for a number of reasons. First, pressured fluids introduced into the production zone or formation carry the risk of clogging the perforations and reducing the production of the well. Secondly, none of the above heater designs can be integrated as part of the production tubing, thus preventing paraffin formation while the heater is in use. There are designs of heaters that can be placed in the producing zone that allow for production to continue while in use. However, these heaters cannot heat the oil to a degree that will allow the oil to reach the surface before cooling and the production tubing becoming clogged. In addition the placement of a heater below the production pump heats the gases that naturally occur in petroleum products and result in the pump becoming gas locked. When the down hole pump becomes gas locked, the well must be turned off for a period of time to allow the gas to move past the pump, freeing it to function again.

### OBJECTS AND SUMMARY OF THE INVENTION

Accordingly, among the objects and advantages of the invention are:
(a) to provide a heat source directly in the tubing line at any point where the paraffin begins to solidify;
(b) to provide a versatile heat source that can be placed at any point in the flow lines and or field lines as needed to prevent the cooling of oil and paraffin formation and clogging;
(c) to provide a system which is not restricted to use in the production zone;
(d) to provide a heat source to both flowing and pumping well, as normal pumping methods;
(e) to prevent interference with the down hole pump due to gas lock from heated gas;
(f) to reduce the need for hot oil services;
(g) to reduce the need for chemical treatment of the oil;
(h) to reduce the need to pull the well for the purpose of cleaning clogged pipes, thus reducing down time and lose of production;
(i) to reduce the risk of loss of production due to pressuring chemicals or steam into the perforations;
(j) to provide a continuously clean production tubing, flow line or field line, allowing for maximum flow and production through these lines.

In accordance with the direct application of heat where it is needed is allowed. This provides producers of crude oil the ability to produce wells more cost effectively. Further objects and advantages of my invention will become apparent from a consideration of the drawings and ensuing description.

The present invention is a significant improvement in the oil production delivery industry and addresses these problems. The present invention provides precise placement of the invention permanently into the piping system, whether in the production tubing, flow lines or field lines. The invention thus allows the producer to supply heat to the crude oil in the areas that the actual cooling occurs, thus eliminating the ability of the paraffin to solidify and clog the pipes.

In accordance with the invention, a system for heating a substance being transferred through production tubing, flow lines or field lines comprising a heating system interposed in said tubing flow lines or field lines between a first point and second point is such that the substance pumped or flowing through between the first and second point is heated.

In a further embodiment, the invention is a heating apparatus for heating oil flowing in a flow pipe comprising a heating apparatus for attachment in between two sections of a flow pipe said heating apparatus having a chamber and heating element for heating a fluid flowing between the two sections of the flow pipe such that the formation of paraffin is minimized.

In another embodiment, the invention is a system for heating a substance conveyed within a pipeline comprising a heating apparatus affixed to a first end of the pipeline and having an orifice for permitting the substance to flow through the heating apparatus said heating apparatus is having a heating chamber proximate to the first orifice and in communication therewith and having a plurality of electric heating elements which heat the substance and a second orifice affixed to the heating chamber for permitting the flow of the heated substance out of the heating chamber and in to a second end of the pipeline.

The invention is also a method for liquefying paraffin in a pipe comprising the following steps: determining a cool zone where paraffin is likely to form and situating a heating system at the pipeline below the cool zone, so that the oil is heated and does not form paraffin or paraffin like deposits as it flows through the cool zone.

### DESCRIPTION OF THE FIGURES

FIG. 1 shows three views of heating apparatus, front view, right side view and end view.

FIG. 2 shows a broken view of heating apparatus.

FIG. 3 shows a view in section of a portion of the roof strata, showing the apparatus of the present invention installed as a section of the production tubing strand in an oil well.

FIGS. 4 and 5 are a section view of any other embodiment of the invention.

FIG. 6 is a section view of a further embodiment of the invention.

### REFERENCE NUMERALS IN DRAWINGS

| | |
|---|---|
| 10 heating apparatus | 11 hollow inner core |
| 12 plurality of holes; | 13 threaded coupling |
| perforations | |
| 14 threaded coupling | 15 suitable closure member (washer) |
| 16 suitable closure member | 17 suitable closure member (washer) |
| (washer) | |
| 18 heat source | 19 electric power supply or steam line |
| 20 conduit | 21 baffle |
| 22 heat source termination | 23 heated fluid chamber |
| 24 moisture free zone | 25 outer case |
| (termination area) | |
| 26 outer case | 27 tapered cap |
| 28 tapered cap | 29 inlet plug |
| 30 outlet plug | 31 slot or opening |
| 32 sucker rod | 33 power or steam source |
| 100 heating systems | 106 heating elements |
| 102 housing | 108 inlet |
| 104 chamber | 110 outlet |
| 112 perforation | 120 heating system |
| 121 inlet | 122 perforated |
| 124 chamber | 126 heating element |

### DESCRIPTION OF THE PREFERRED EMBODIMENT

The present invention is described with reference to the enclosed Figures. The invention is specifically directed to a system for heating the flow of oil or any other substances through a pipe, production tubing, field line or flow line. The pipe may comprise a pipeline or a production pipe. The invention specifically comprises a heating system or apparatus interposed between a section of pipe where there is a likelihood of paraffin deposition. The heating system includes a heating system comprising a heating element directly, which heats the substance as it flows through the system.

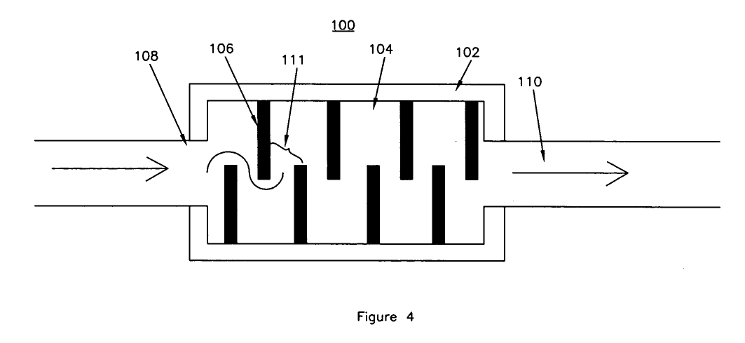

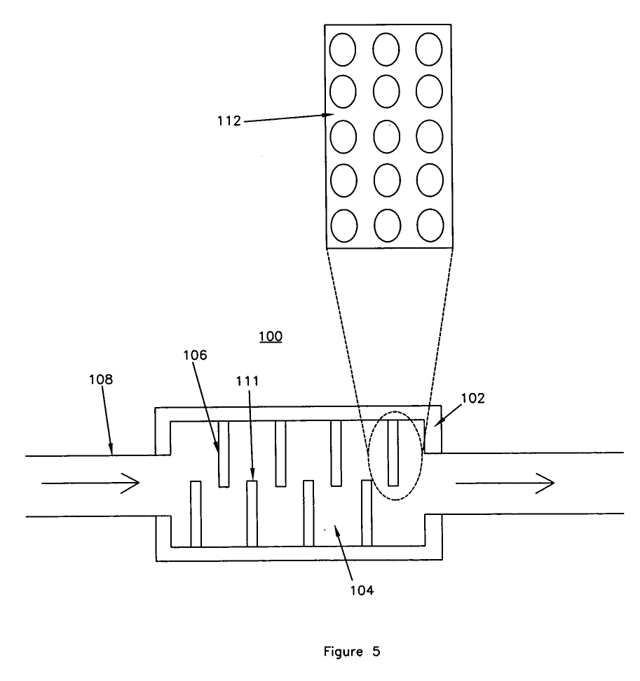

As shown in FIGS. 4 and 5, a most basic embodiment of the present invention is shown. As shown, heating system 100 is designed to be interspersed at a point in a pipeline or production pipe proximate to an area where paraffin formation may occur. In the simple embodiment, of Fugues 4 and 5, the heating system comprises a housing 102 having a chamber 104. The chamber 104 includes one or more heating elements 106. The chamber as an inlet 108 and outlet 110 to permit the substance to be heated to flow therethrough (see arrows). As shown in FIGS. 4 and 5, the heating elements may be interspersed in a zigzag fashion 111 and may be perforated 112.

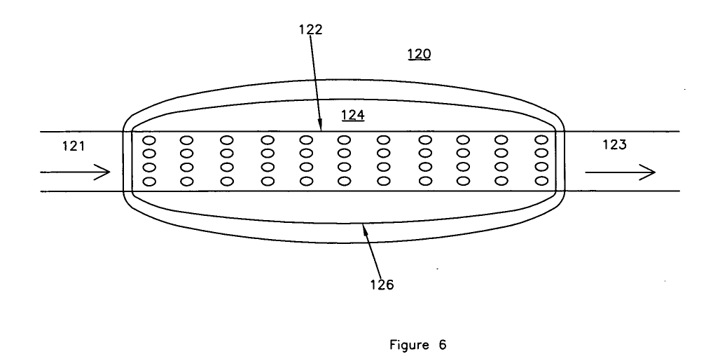

FIG. 6 illustrates still another embodiment of the invention. This embodiment comprises a heating apparatus or system 120. The system is interspersed between sections of pipe and includes an inlet 121 and outlet 123. In this embodiment, the system comprises an inner perforated tubing 122 which permits the substance to flow into a chamber 124. The chambers has heating element 126 which heats the substance and permits it to flow, as heated back through the perforated tube and onward.

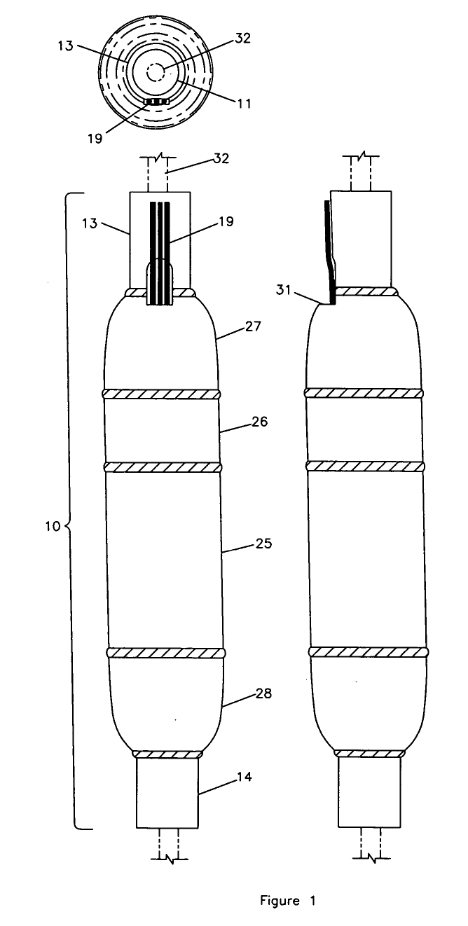

A more comprehensive embodiment is illustrated in FIGS. 1 to 3. Referring to the embodiment shown in FIGS. 1 through 3, here like numerals indicate like parts throughout the several views. The heating apparatus 10 comprises an inner hollow cylindrical tube 11. Tube 11 is of predetermined dimensions, threaded at each end (not shown) and comprises a plurality of holes or perforations 12. Perforations 12 are arranged in space relation along tube 11. Tube 11 in combination with threaded couplings 13 and 14 comprise a continuous inner core of predetermined dimensions. Couplings 13 and 14 and tube 11 are constructed from suitable material and specifications to allow the heating apparatus 10 to be integrated into the production tubing, flow lines or field lines in the oil production industry.

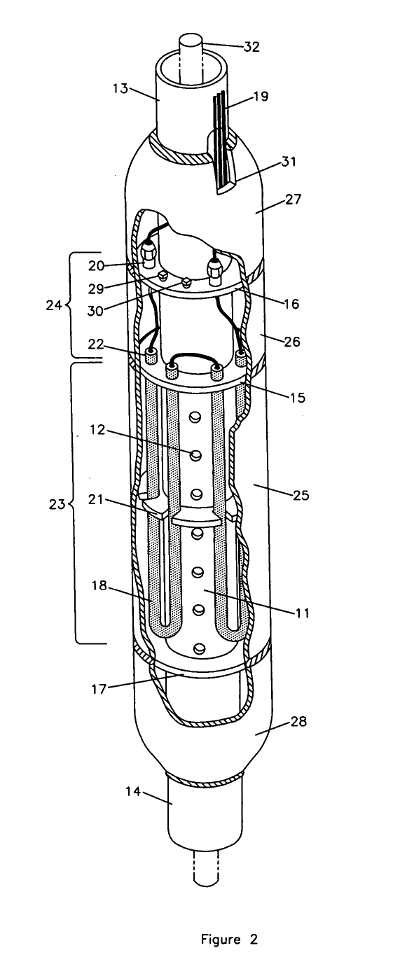

Suitable closure members 15, 16 and 17, resembling large washers, are attached by welding or other appropriate means at predetermined intervals along tube 11. Washers 15 and 16 having a plurality of holes as needed to allow for heat source 18 termination and electrical or steam supply 19 access. As indicated in FIG. 2 of the drawings the heat source 18 terminations or leads 22 pass through suitable openings in washer 15 and are sealed by appropriate means. Washer 15 is attached above the perforated section of tube 11. Washer 16 is attached to tube 11 above washer 15 and comprises suitable openings which allow for conduits 20, compatible with electrical or steam energy source 19 to be installed and sealed.

In the preferred embodiment baffle(s) 21 are placed at predetermined intervals to tube 11 and appropriately secured. Baffle(s) 21 support and space heat source 18 along tube 11. Near the lower end of tube 11, washer 17 is placed just below the perforations 12. Washer 17 is appropriately secured to tube 11 and sealed. Washers 15, 16 and 17 in combination will create a series of chambers 23 and 24, along tube 11.

The heat source 18 passes through washer 15, terminates 22 and seals as needed to satisfy the heat source 18 requirements. There are a variety of options for heat source 18 that can be utilized. Between washer 15 and 16 a suitable source of electrical or steam energy 19, which may be employed for the supply of electrical current or steam, to the heat source 18, are connected to the leads or terminations 22 of heat source 18. In this connection, it is pointed out, all electrical wiring and connections are to be flash ignition proof and properly insulated.

Outer cases 25 and 26 are of a material appropriate for use in the oil industry. Outer case 25 is properly secured and sealed to washers 17 and 15 forming sealed chamber 23. Chamber 23 encapsulates heat source 18 and the perforated section of tube 11. Outer case 26 is secured and sealed to washers 15, 16 and outer case 25 forming a sealed chamber 24. Chamber 24 is a moisture proof chamber encapsulating the terminal were the heat source and energy supply source connect. Chamber 24 is to be flushed of all oxygen by nitrogen replacement when electrical energy is utilized. Plugs 29 and 30 provide inlets and outlets for this process.

The heating apparatus has tapered caps 27 and 28 interconnected to outer case 25 and 26. Cap 27 comprises a slot or opening 31 or predetermined size allowing passage of any suitable electrical or steam energy supply source 19. Cap 27 is interconnected with case 26, washer 16 and coupling 13 by welding or other suitable means. Cap 28 is interconnected to case 25, washer 17 and coupling 14 in a like manner as cap 27. Caps 27 and 28 are configured in a tapered manner to allow easy entrance and exit in the casing when my heating apparatus 10 is incorporated into the production tubing strand.

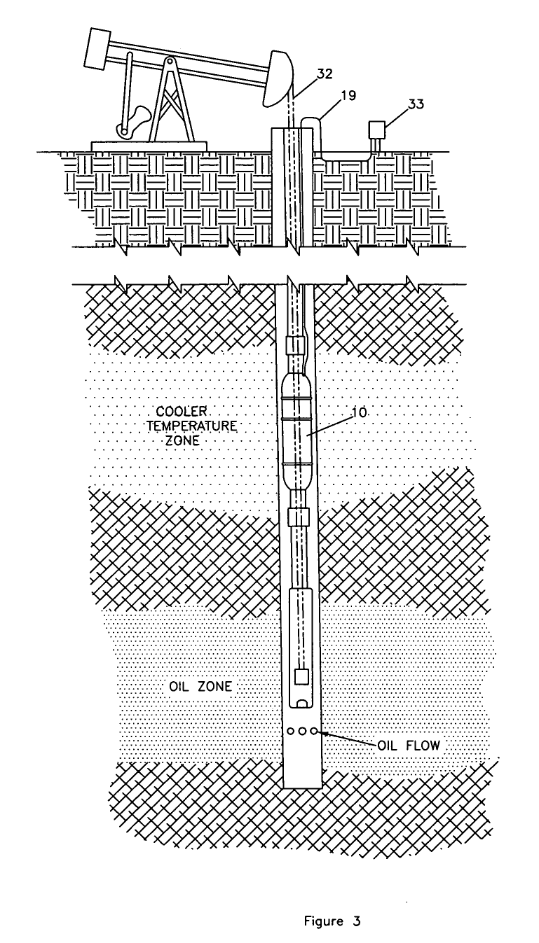

In FIG. 3 heating apparatus 10 is incorporated into the production tubing. The sucker rod 32 passes through the heating apparatus. The electrical or steam supply line 19 is attached to heating apparatus 10 and the main supply source above ground 33.

From the description above, a number of advantages of the apparatus become evident:
(1) Constant heat can be supplied to the production fluid without interruption of production.
(2) The heating apparatus can be incorporated anywhere in the production tubing, flow line or field lines as is needed.
(3) The production by means of the pumping jack with rods can operate normally through the heating apparatus.
(4) The downtime for maintenance or well due to paraffin treatment is reduced to a minimum.
(5) The use of chemical treatments is reduced to a minimum.
(6) The use of the heating apparatus of the present invention results in a continuously clean piping system by preventing deposition of paraffin in the trouble areas.
(7) Maximum production is achieved by minimizing clogging of production tubing, flow lines and field lines.

### Operation of the Invention

The operation of the heating apparatus 10 is now described. Prior to employing the preferred method of preventing the build up of paraffin and paraffin-like deposits in the production tubing, flow lines and field lines, all prior attempts were to treat deposits after they occurred. By incorporating the heating apparatus 10 into the production tubing, flow lines or field lines minimal, in any, deposits will occur.

The manner of using the in line heating apparatus 10 in the production tubing line is to pull the existing tubing strand, by the conventional means practiced in the industry. Next, the area in the tubing strand that exhibits paraffin or paraffin-like deposits must be located. These deposits indicate where in the tubing line oil begins to cool, thus resulting in paraffin solidification.

When returning the tubing strand to the production hole, the heating apparatus 10 should replace a joint of tubing at a point just below or before the noted paraffin formation point. The heating apparatus is designed in such a manner as to allow normal integration into the tubing strand by means of the threaded couplings 13 and 14 located at each end of the apparatus.

The electrical or steam supply source 19 is connected to the heating apparatus 10 before it is lowered into the production hole, and the line is fed into the well as the tubing and heating apparatus 10 are replaced. The electrical or steam supply line 19 is periodically secured to the tubing strand in a manner which is practiced in the petroleum industry.

Once the tubing strand has been fully restored, the electrical or steam supply source 19 is connected to a switchbox or steam supply pump 33 located on the surface.

Normal production of the well resumes, either flowing or pumping. The popular means of pumping by use of a pumping jack, sucker rods and down hole pump can be employed with my preferred embodiment because it allow the sucker rod 32 to operate through my heating apparatus 10 as shown in FIG. 3.

The oil well is put back into operation, by pumping or flowing. A flow meter (not shown) at the wellhead is used to monitor the flow of fluids from the well. When a sufficient flow is reached and the tubing is noted to be fluid filled the electrical power or steam supply source 19 and 33 to the heating apparatus 10 is engaged.

Normal pressure and movement of the fluid in the production tubing as it moves through the heating apparatus 10 forces the fluid through the perforations 12 of the inner core 11 and into chamber 23. Here the production fluid moves through chamber 23 and is making contact with the heat source 18. The fluid moves upward through chamber 23, circulating through the perforations 12, and exiting tube 11 at the top. During the period the fluid was moving through heating apparatus 10 the temperature was raised by contact with the heat source. This raise in temperature keeps the paraffin suspended in the oil. As the fluid continues through the production tubing to the surface, the increased temperature achieved by contact with the heating apparatus prevents paraffin and paraffin-like deposits from occurring in the tubing.

When incorporating the heating apparatus 10 into the flow or field lines, it is best to locate the trouble areas in the existing line and replace the joint just prior to the clogged joint. Adding the heating apparatus just prior to the previous trouble spots increases the temperature of the fluid before the paraffin begins to solidify and clog the lines minimizing the chance of any future deposits.

Maintaining fluid temperature as it travels from the production zone to the surface is the only means of preventing paraffin solidification. The apparatus provides the heat source were it is needed with a constant heat while production occurs. Furthermore, the heating apparatus offers additional advantages:

It permits the heating apparatus to be installed during regular maintenance of the well, eliminating the expense of pulling the well exclusively to install the apparatus;
It allows the well to be produced without the expense of treatment chemicals;
It provides a way to produce the well without the downtime and expense of hot oil services;
It prevents the risk of paraffin and paraffin-like deposits from ever forming in the production tubing, flow lines or field lines;
It reduces risk of loss of production due to downtime to treat paraffin deposits;
It reduces risk of loss of production caused by other treatment methods that result in clogged perforations; and

It provides a cost effective means of preventing paraffin deposition in the production tubing, flow lines and field lines.

Although the above description contains many specifications, these should not be construed as limiting the scope of the invention, but as merely providing illustrations of some of the presently preferred embodiments of this invention. Various modifications will be apparent to and can be readily made by those skilled in the art to which the invention pertains without departing form the spirit and scope of the invention. As noted herein the present invention can be used in any application where heating or elimination of paraffin, or any other substance, is required including pipelines, oil wells, or steam lines. Accordingly, the scope of the invention and its method should be determined not by the embodiment(s) illustrated, but by the appended claims and their equivalents.

1. A system for heating a substance being transferred through production tubing, flow lines or field lines comprising:
a heating system interposed in said tubing flow lines or field lines between a first point and second point is such that the substance pumped or flowing through between the first and second point is heated.

2. An apparatus to be located in the production tubing, flow line or field line conveying production fluid at a point of paraffin or paraffin-like formation comprising:
a heating system having couplings compatible with each end of the production tubing, flow line or field line to which it is to be attached; and
a chamber for permitting the flow of production fluid therein and having at least one heating element, such that the element heats the production fluid to a temperature sufficient to eliminate the solidification of paraffin or paraffin like substances.

3. A heating apparatus for heating oil flowing in a flow pipe comprising:
a heating apparatus for attachment in between two sections of a flow pipe said heating apparatus having a chamber and heating element for heating a fluid flowing between the two sections of the flow pipe such that the formation of paraffin is minimized.

4. A system for heating a substance in a pipe comprising:
a heating system comprising an inlet affixed to a pipe section conveying a substance to be heated from a first pipe section, and an outlet for permitting the heated substance to exit the heating system and enter the second pipe section;
a heat chamber between the inlet and outlet and having a plurality of heating elements for heating the substance as it flows between the first and second pipe sections.

5. The system of claim 4 wherein the heating element is a chamber having a perforated tube and having a plurality of heating elements.

6. The system of claim 4 is shown wherein the substance is oil.

7. The system of claim 4 wherein the substance is steam.

8. A system for heating a substance conveyed within a pipeline comprising:
a heating apparatus affixed to a first end of the pipeline and having an orifice for permitting the substance to flow through the heating apparatus;
said heating apparatus is having a heating chamber proximate to the first orifice and in communication therewith and having a plurality of electric heating elements which heat the substance; and
a second orifice affixed to the heating chamber for permitting the flow of the heated substance out of the heating chamber and in to a second end of the pipeline.

9. A method for liquefying paraffin in the production tubing, flow line, field or any other pipe comprising the following steps:
determine the area in the production tubing, flow line field line or other pipeline where paraffin or any other blockage is likely to form; and situating a heating system at or before the problem area, so that the substance is heated and does not allow for formation of paraffin, paraffin like deposits or any other blockage as it flows through the piping system.
